(19) United States
(12) Patent Application Publication
(10) Pub. No.: US 2026/0016803 A1
(43) Pub. Date: Jan. 15, 2026

(54) PROGRAMMABLE CONTROLLER

(71) Applicant: Mitsubishi Electric Corporation, Tokyo (JP)

(72) Inventor: Masataka HASHISHITA, Tokyo (JP)

(73) Assignee: Mitsubishi Electric Corporation, Tokyo (JP)

(21) Appl. No.: 18/880,289

(22) PCT Filed: Aug. 8, 2022
(86) PCT No.: PCT/JP2022/030279

§ 371 Date: Dec. 31, 2024

(51) Int. Cl. G05B 19/05; G06F 21/60

(52) U.S. Cl. CPC G05B 19/058; G05B 19/052; G06F 21/604

(57) ABSTRACT

A programmable logic controller includes a communicator that receives an access event from an external device and performing communication through a network (NW), a trainer that trains a model to identify an exceptional access event occurring less frequently than other access events based on a history of access events received by the communicator, a detector that detects the exceptional access event from a new access event received by the communicator using the model trained by the trainer, and a processor that processes the exceptional access event detected by the detector.

### TECHNICAL FIELD

The present disclosure relates to a programmable controller, an exceptional access learning method, and a program.

### BACKGROUND ART

Recent systems including a network used at factory automation (FA) sites have received attention for security, and associated techniques have been developed (see, for example, Patent Literature 1). Patent Literature 1 describes a security patch for responding to attacks that exploit vulnerabilities of programmable logic controllers (PLCs).

### CITATION LIST

### Patent Literature

Patent Literature 1: Unexamined Japanese Patent Application Publication (Translation of PCT Application) No. 2019-527877

### SUMMARY OF INVENTION

### Technical Problem

The technique in Patent Literature 1 is not directed to responding to attack methods, such as Denial of Service (DoS), that improperly use access unrelated to PLC vulnerabilities, such as simple reading or writing of data. In situations where such access events are allowed, the data in a PLC may be read by an attacker or unauthorized data is written to a PLC by an attacker eventually. This may cause the PLC to malfunction. Thus, PLCs are to be more durable against unauthorized access events.

Under such circumstances, an objective of the present disclosure is to improve the durability of PLCs against unauthorized access events.

### Solution to Problem

To achieve the above objective, a programmable controller according to an aspect of the present disclosure includes communication means for receiving an access event from an external device and performing communication through a network, training means for training a model to identify an exceptional access event occurring less frequently than other access events based on a history of access events received by the communication means, detection means for detecting the exceptional access event from a new access event received by the communication means using the model trained by the training means, and processing means for processing the exceptional access event detected by the detection means.

### Advantageous Effects of Invention

In the above aspect of the present disclosure, the detection means detects an exceptional access event, and the processing means processes the exceptional access event. Unauthorized access events occur less frequently than access events that occur during normal operation. Thus, unauthorized access events can be responded by processing exceptional access events. This improves the durability of the PLC against unauthorized access events.

### BRIEF DESCRIPTION OF DRAWINGS

FIG. 1 is a schematic diagram of a PLC system according to Embodiment 1;

FIG. 2 is a diagram of an FA device according to Embodiment 1, illustrating the hardware configuration;

FIG. 3 is a diagram of an example of information stored in a storage in Embodiment 1;

FIG. 4 is a diagram of a block shared by a sharer in Embodiment 1;

FIG. 5 is a diagram of the block with a second structure in Embodiment 1;

FIG. 6 is a diagram describing training with a trainer in Embodiment 1;

FIG. 7 is a flowchart of a PLC process in Embodiment 1;

FIG. 8 is a flowchart of an access information recording process in Embodiment 1;

FIG. 9 is a flowchart of a sharing process in Embodiment 1;

FIG. 10 is a diagram illustrating communication among nodes in Embodiment 1;

FIG. 11 is a flowchart of a provisional transaction generation process in Embodiment 1;

FIG. 12 is a flowchart of a request node process in Embodiment 1;

FIG. 13 is a flowchart of a reception node process in Embodiment 1;

FIG. 14 is a flowchart of a management node process in Embodiment 1;

FIG. 15 is a flowchart of a training process in Embodiment 1;

FIG. 16 is a flowchart of a detection process in Embodiment 1;

FIG. 17 is a diagram of access information in Embodiment 2; and

FIG. 18 is a diagram of access information in Embodiment 3.

### DESCRIPTION OF EMBODIMENTS

A data collection system according to one or more embodiments of the present disclosure is now described in detail with reference to the drawings.

### Embodiment 1

A programmable logic controller (PLC) system 1000 according to the present embodiment is constructed as a control system for controlling equipment at a factory through a network. The PLC system 1000 is a factory automation (FA) system for operating, for example, a production line, a machining process line, an inspection line, and other processes. In the PLC system 1000, each device records and shares external access events in the form of a distributed ledger, and trains a model for identifying exceptional access events based on shared records. When an exceptional access event is detected with the trained model, a process is performed on the access event.

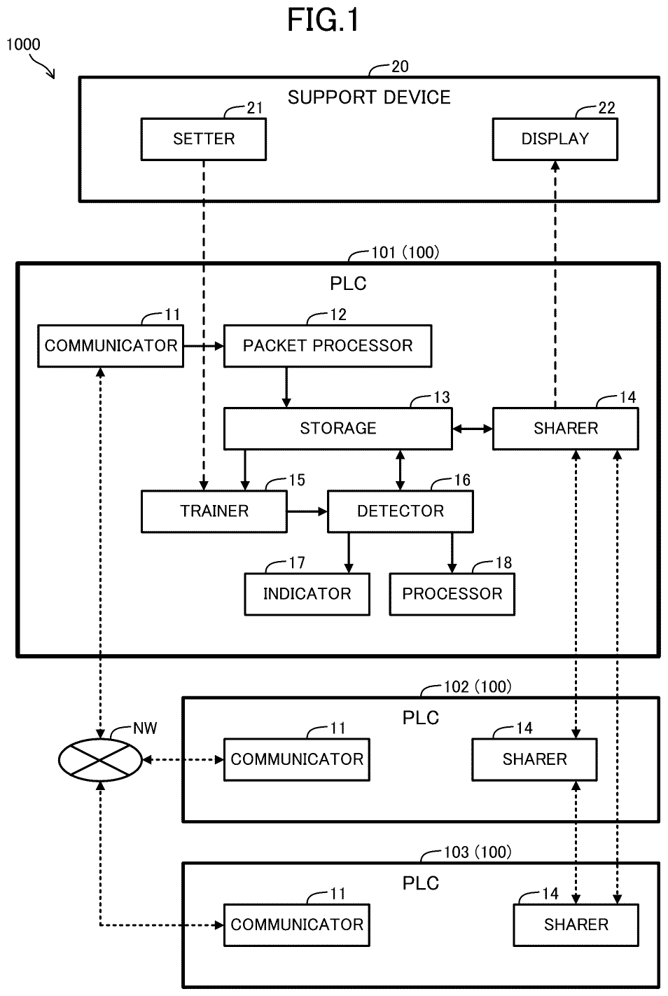

As illustrated in FIG. 1, the PLC system 1000 includes PLCs 101, 102, and 103 connected to one another with a network NW, and a support device 20 that functions as a user interface terminal for the PLC 101. The network NW may be an industrial network or an information network. In the network NW, for example, packets are transmitted under Transmission Control Protocol (TCP)/Internet Protocol (IP). The support device 20 and the PLC 101 are connected with a communication line such as a universal serial bus (USB) cable or a network such as a local area network (LAN).

The PLCs 101, 102, and 103 have the same components and implement the same functions. FIG. 1 illustrates the configuration of the PLC 101 in detail, with the configurations of the PLCs 102 and 103 being simplified. The PLCs 101, 102, and 103 may each be hereafter referred to as a PLC 100 without distinction.

The PLC 100 is a control device that controls equipment (not illustrated) by executing a control program represented by a ladder program. The PLC 100 may cooperate with other PLCs 100 to control the equipment. For example, the PLC 101 acquires a sensing result from a sensor, and the PLC 101 or the PLC 102 outputs an operation command based on the sensing result to an actuator to transport workpieces on a conveyor belt. The PLC 100 corresponds to an example of a programmable controller.

The support device 20 is an industrial personal computer (PC) and includes application software referred to as an engineering tool for creating and editing control programs to be executed by the PLCs 100 and writing the control programs to the PLCs 100.

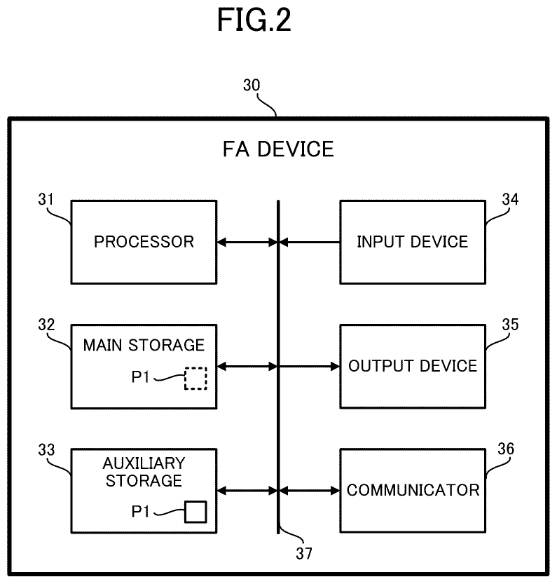

The PLCs 100 and the support device 20 each include hardware components to function as a computer. More specifically, as illustrated in FIG. 2, an FA device 30 corresponding to each of the PLCs 100 and to the support device 20 includes a processor 31, a main storage 32, an auxiliary storage 33, an input device 34, an output device 35, and a communicator 36. The main storage 32, the auxiliary storage 33, the input device 34, the output device 35, and the communicator 36 are connected to the processor 31 with an internal bus 37.

The processor 31 includes a central processing unit (CPU) as a processing circuit. The processor 31 executes a program P1 stored in the auxiliary storage 33 to implement various functions to perform the processes described later. The program P1 in the support device 20 corresponds to the above engineering tool. The processor 31 in the PLC 100 executes the above control program in addition to the program P1.

The main storage 32 includes a random-access memory (RAM). The program P1 is loaded into the main storage 32 from the auxiliary storage 33. The main storage 32 is used as a work area for the processor 31.

The auxiliary storage 33 includes a nonvolatile memory such as an electrically erasable programmable read-only memory (EEPROM) and a hard disk drive (HDD). In addition to the program P1, the auxiliary storage 33 stores various sets of data used in processing performed by the processor 31. The auxiliary storage 33 provides data to be used by the processor 31 to the processor 31 as instructed by the processor 31. The auxiliary storage 33 stores data provided by the processor 31.

The input device 34 includes input devices such as a hardware switch, an input key, a keyboard, and a pointing device. The input device 34 acquires information input by the user of the FA device 30 and notifies the processor 31 of the acquired information.

The output device 35 includes output devices such as a light-emitting diode (LED), a liquid crystal display (LCD), and a speaker. The output device 35 presents various items of information to the user as instructed by the processor 31.

The communicator 36 includes a communication interface circuit for communicating with external devices. The communicator 36 receives external signals and outputs data indicated by these signals to the processor 31. The communicator 36 transmits a signal indicating the data output from the processor 31 to external devices. Although FIG. 2 illustrates the single communicator 36 as a typical example, the FA device 30 may include multiple communicators 36. For example, the FA device 30 serving as the PLC 101 may separately include a communicator 36 for communicating with the support device 20 and a communicator 36 for communicating through the network NW.

The hardware components described above cooperate with one another to allow the PLCs 100 and the support device 20 to implement various functions. More specifically, as illustrated in FIG. 1, the PLC 101 includes, as functional components, a communicator 11 that receives external access events and perform communication through the network NW, a packet processor 12 that processes packets received by the communicator 11 to generate access information about access events, a storage 13 that accumulates and stores the access information, a sharer 14 that shares the access information with the PLCs 102 and 103, a trainer 15 that trains a model for identifying an exceptional access event based on the access information, a detector 16 that detects an exceptional access event based on the trained model, an indicator 17 that indicates the exceptional access event to the user, and a processor 18 that processes the exceptional access event.

The communicator 11 is mainly implemented by the processor 31 and the communicator 36 in the PLC 101 cooperating with each other. Reception of access events by the communicator 11 indicates that the PLC 101 receives, through the network NW, packets having the destinations being the PLC 101. In FIG. 1, the PLCs 102 and 103 are illustrated as devices accessing the communicator 11, but other devices (not illustrated) can access the communicator 11 through the network NW. The communicator 11 transmits packets to the network NW as appropriate. The communicator 11 in each PLC 100 corresponds to an example of communication means for receiving an access event from an external device through a network.

The packet processor 12 is mainly implemented by the processor 31 in the PLC 101. The packet processor 12 receives packets from the communicator 11 and processes the packets to generate access information about access events to the communicator 11.

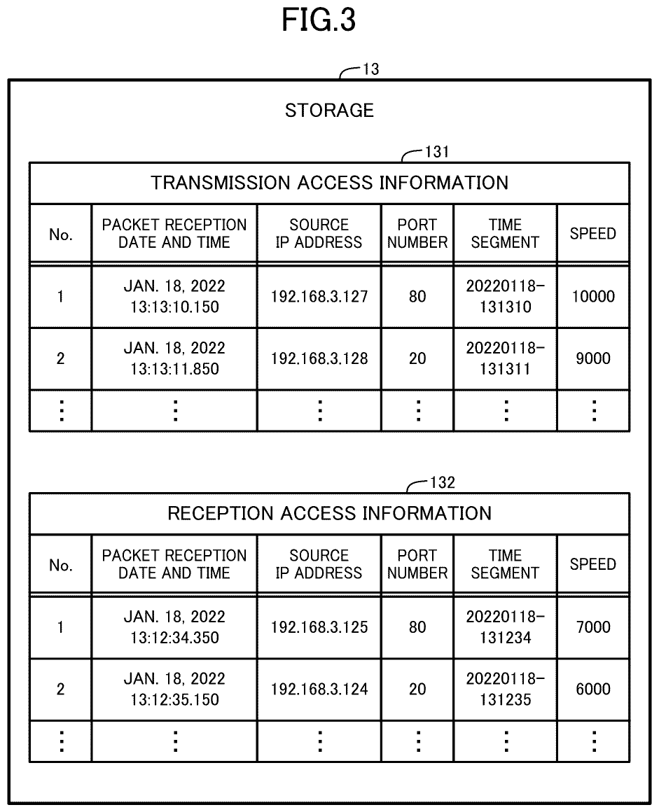

The access information includes identification information identifying a communication device that has caused an access event in the network NW and at least one of the time of the access event or a predetermined time segment including the time. For example, the access information is a record corresponding to one line of transmission access information 131 illustrated in FIG. 3. The access information indicates, in a manner associated with one another, the packet reception date and time as the time of access, the source IP address as the identification information, the port number specified in the packet, the time segment in seconds including the reception date and time, and the speed corresponding to the frequency of access events.

The length of the time segment is one second in the example in FIG. 3, but is not limited to one second and may be changed as appropriate. In FIG. 3, the “20220118-131310” indicates a segment of one second from 13:13:10 to 13:13:11 on Jan. 18, 2020. The speed indicates the size of the packet received for the access event that has occurred in the time segment in bits per second (bps). In FIG. 3, the time segment length is one second, and thus the speed is equal to the size of the packet. The size of the packet received in one time segment is equal to the total of the bit values included in the packets received by the communicator 11. More specifically, the speed corresponds to the frequency of access events for each bit value in one time segment. When the reception of one packet is not complete within one time segment, all the bit values in the packet can be treated as being received at the reception date and time of the packet.

The storage 13 is mainly implemented by at least one of the main storage 32 or the auxiliary storage 33 in the PLC 101. As illustrated in FIG. 3, the storage 13 stores, as access history, the transmission access information 131 that is a set of access information generated by the packet processor 12 and reception access information 132 generated by the PLCs 102 and 103 and received from the PLCs 102 and 103.

The transmission access information 131 is transmitted from the PLC 101 to the PLCs 102 and 103 for sharing among the PLCs 100. The reception access information 132 indicates access events to the PLCs 102 and 103 other than to the PLC 101. The reception access information 132 is received by the PLC 101 from the PLCs 102 and 103 for sharing among the PLCs 100. The transmission access information 131 and the reception access information 132 may each have a number assigned to each piece of access information as illustrated in FIG. 3.

The transmission access information 131 corresponds to an example of first access information. The reception access information 132 corresponds to an example of second access information.

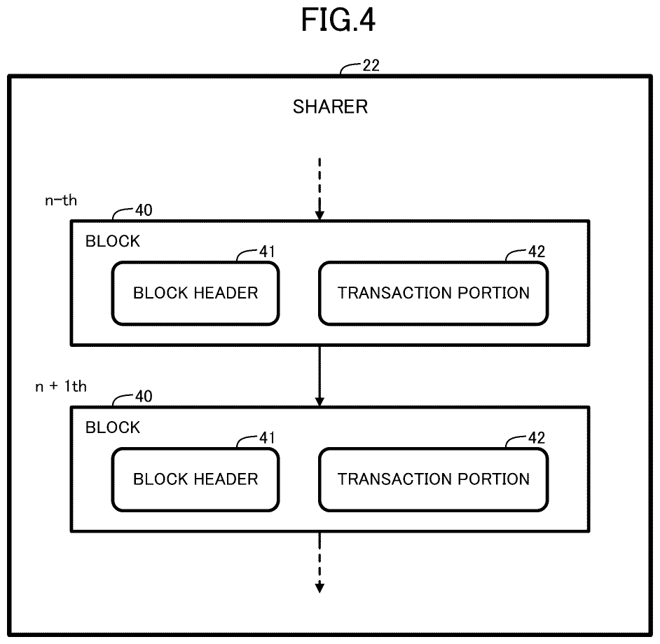

Referring back to FIG. 1, the sharer 14 is mainly implemented by the processor 31 and the communicator 36 in the PLC 101 cooperating with each other. The sharer 14 shares the transmission access information 131 and the reception access information 132 stored in the storage 13 with the PLCs 102 and 103 in the form of a distributed ledger. More specifically, as illustrated in FIG. 4, the sharer 14 shares information by linking a block 40, including a block header 41 and a transaction portion 42, with the previous block 40 and sequentially generating such blocks 40.

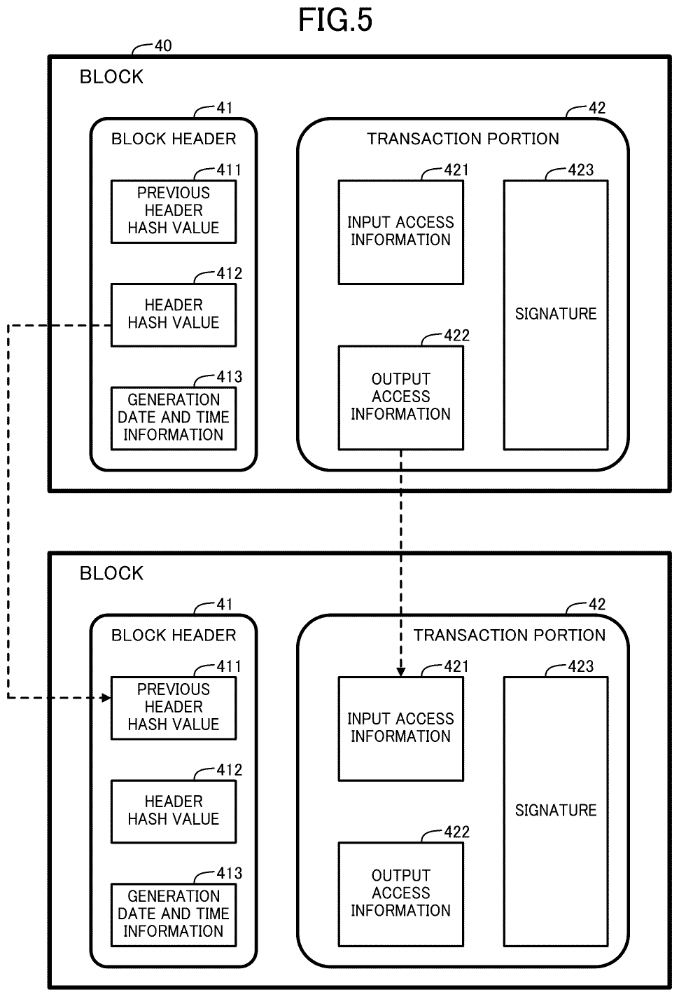

As illustrated in FIG. 5, the block header 41 includes a previous header hash value 411 equal to a header hash value 412 of the block header 41 in the previously generated block 40, a header hash value 412 that is a data hash value included in the block header 41, and generation date and time information 413 indicating the date and time at which the block 40 is generated. The transaction portion 42 includes input access information 421 including output access information 422 in the transaction portion 42 in the previous block 40, output access information 422 including access information to be added to the block 40, and a signature 423 for the input access information 421 and the output access information 422.

The PLCs 100 share, among one another, adding of a block 40 to be newly linked and including the access information to be shared as the output access information 422, thus sharing the access information. More specifically, adding the block 40 including the transmission access information 131 provided from the PLC 101 allows the PLCs 102 and 103 to acquire the transmission access information 131 from the PLC 101. The transmission access information 131 is shared with the PLCs 102 and 103. Adding a block including access information provided from the PLC 102 or the PLC 103 allows the PLC 101 to acquire the access information recorded in the PLC 102 or the PLC 103. The access information is shared with the PLC 101 as the reception access information 132.

The input access information 421 may include information acquired by processing the output access information 422 in the previous block 40. The input access information 421 may be an identifier (ID) of the transaction portion 42 in the previous block 40 and information acquired by processing the output access information 422 included in the transaction portion 42.

The sharer 14 may use at least one of the main storage 32 or the auxiliary storage 33 in the PLC 101 to function as a storage device different from the storage 13. More specifically, the sharer 14 may store the blocks 40 sequentially linked, and synchronize the output access information 422 in the blocks 40 with the storage 13.

Three methods for linking blocks for a distributed ledger, or private chains, consortium chains, and public chains, are known. Users of the PLCs 100 usually do not intend to disclose such access information to external third parties. Thus, private or consortium chains may be used to set participation of each PLC 100 in a blockchain. The sharer 14 in each PLC 100 corresponds to an example of sharing means for sharing the transmission access information 131 and the reception access information 132 with another programmable controller in the form of a distributed ledger.

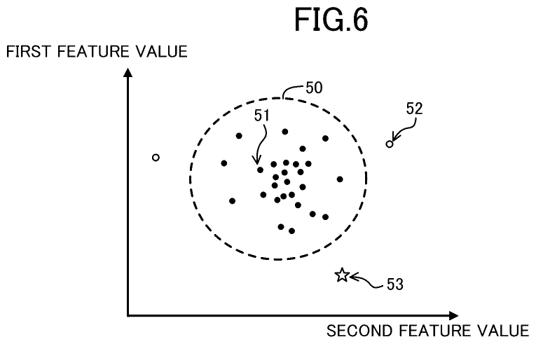

Referring back to FIG. 1, the trainer 15 is mainly implemented by the processor 31 in the PLC 101. The trainer 15 trains a model for identifying an exceptional access event that occurs less frequently than other access events from the access information stored in the storage 13. For example, the trainer 15 extracts feature values from the individual access information pieces and fits the distribution of the feature values to a normal distribution. FIG. 6 schematically illustrates the training of the model through normal distribution fitting.

In the example in FIG. 6, the solid circles and outlined circles represent sampling points defined by a first feature value and a second feature value extracted from the individual access information pieces. The first feature value may be, for example, the source IP address or a group of source IP addresses indicated by the access information. The second feature value may be, for example, the port number or a group of port numbers indicated by the access information. The first feature value and the second feature value may be any other feature values calculated from the access information. An area 50 illustrates 3a of the normal distribution of these sampling points resulting from fitting. Access events normally observed correspond to sampling points 51 represented by the solid circles inside the area 50, and exceptional access events correspond to sampling points 52 represented by the outlined circles outside the area 50. When an exceptional access event is identified based on whether the access event is in the area 50, the area 50 corresponds to a model for identifying an exceptional access event. In the example in FIG. 6, an exceptional access event is an access event with a feature value that is extracted less frequently than in other access events and outside the range of feature values extracted frequently from other access events.

The training method used by the trainer 15 may be changed as appropriate. Among three known training methods, or unsupervised learning, supervised learning, and reinforcement learning, unsupervised learning may be used. Unsupervised learning can identify exceptional access events by tuning parameters under the situation in which each access event is not known whether the access event corresponds to an exceptional access event. Access events through the network NW are usually normal and unauthorized access events are far fewer than normal access events. Based on this as well, unsupervised learning may be used. Supervised learning may be used when a label correctly indicating whether an access event is an exceptional access event can be pre-assigned to each piece of access information by a supervisor. When a reward resulting from applying the model and detecting an exceptional access event can be designed, reinforcement learning may be used.

The trainer 15 may train different models for different time segments. For example, the trainer 15 may train, as models, different areas 50 for different time segments using the first feature value illustrated in FIG. 6 as the source IP address and the second feature value as the port number. The trainer 15 may train, as models, different areas 50 for different time segments using the first feature value illustrated in FIG. 6 as the source IP address and the second feature value as the port number. The trainer 15 may train, based on multiple access events that occur in a relatively long time segment such as one day or one month, a model for use in the time segment to detect an exceptional access event on the same date or the same calendar month in the future using the model. In another example, access events that occur in a relatively short time segment, such as one minute or one hour, may be collected for one day or multiple days. After the trainer 15 trains a model with the collected access events, the trained model corresponding to the time segment in which a new access event has occurred may be used to identify the new access event as an exceptional access event or not. The trainer 15 in each PLC 100 corresponds to an example of training means for training a model to identify an exceptional access event.

Referring back to FIG. 1, the detector 16 is mainly implemented by the processor 31 in the PLC 101. The detector 16 detects an exceptional access event from the access events indicated by the access information stored in the storage 13 using the model trained by the trainer 15.

When, for example, an exceptional access event is identified with the area 50 illustrated in FIG. 6, the detector 16 detects the sampling points 52 corresponding to the access events in the past and located outside the area 50 as exceptional access events. When an access event that is the same as or similar to the sampling points 52 occurs in the future, the detector 16 detects that access event as an exceptional access event. The past herein refers to the time before the model is trained, and the future herein refers to the time after the model is trained. The access event similar to the sampling points 52 corresponds to a new point (not illustrated) near either of the sampling points 52 in FIG. 6. Further, the detector 16 also detects, as an exceptional access event, a sampling point 53 not similar to any of the past access events using the area 50. In this manner, the model may identify an unknown access event as an exceptional access event or not.

In the example illustrated above, the model identifies exceptional access events that occur less frequently than other access events based on the distribution of sampling points corresponding to access events. However the embodiment is not limited to this structure. For example, the weight corresponding to the speed illustrated in FIG. 3 may be multiplied by the sampling points. The frequency as a speed may be used as a feature value, and an access event with the feature value less than a threshold may be identified as an exceptional access event. The feature values may include one type or more than three types of feature values. The detector 16 in each PLC 100 corresponds to an example of detection means for detecting an exceptional access event from a new access event received by the communication means.

Referring back to FIG. 1, the indicator 17 is mainly implemented by the processor 31 and the output device 35 in the PLC 101 cooperating with each other. The indicator 17 may indicate the detection results from the detector 16 with a user interface to indicate the results to the user through the user interface. The user interface may be an output device included in the output device 35 or the support device 20 as a user interface terminal.

The processor 18 is mainly implemented by the processor 31 included in the PLC 101. The processor 18 processes packets received by the communicator 36 based on the detection results from the detector 16. More specifically, the processor 18 allows access events other than exceptional access events to pass through the processor 18 and starts a process based on the access events other than exceptional access events. For example, the processor 18 reads, based on an access event requesting reading of data stored in the PLC 101, the data and causes the communicator 11 to respond to the access event. The processor 18 writes, based on an access event requesting writing of data to the PLC 101, the data and causes the communicator 11 to indicate completion of the writing as a response.

The processor 18 blocks an exceptional access event. More specifically, the processor 18 discards the packets of an exceptional access event requesting reading of data, without reading the data or responding to the exceptional access event. The processor 18 discards the packets of an exceptional access event requesting writing of data, without writing the data. The processor 18 may also record any exceptional access event or may cause the indicator 17 to indicate the exceptional access event. The processor 18 in each PLC 100 corresponds to an example of processing means for processing the exceptional access event detected by the detection means.

The support device 20 includes a setter 21 for setting the training parameters to be used by the trainer 15 in the PLC 101, and a display 22 for displaying information shared by the sharer 14 to the user.

The setter 21 is mainly implemented by the processor 31 and the communicator 36 in the support device 20. The setter 21 receives, from the user, parameters for the training speed and identification accuracy for exceptional access events and sets the parameters in the trainer 15. The display 22 is mainly implemented by the output device 35 in the support device 20.

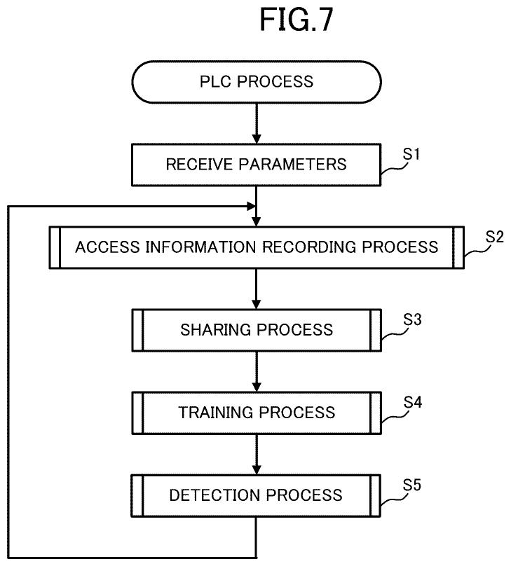

A PLC process performed by each PLC 100 having the above functions is now described with reference to FIGS. 7 to 16.

The PLC process illustrated in FIG. 7 is started when the PLC 100 is powered on. To clarify the relationship between the steps in the PLC process, the steps are illustrated as being performed in sequence, but the embodiment is not limited to this structure. Each step may be performed in parallel.

In the PLC process, the PLC 100 receives parameters for the trainer 15 from the support device 20 (step S1) and sets the parameters in the trainer 15. The parameters may be quantitative values or qualitative values, such as a classification of “fast” or “slow” for training speed or “loose” or “strict” for identification accuracy. The PLC 100 then repeatedly performs an access information recording process of recording access information based on access events from outside the PLC 100 (step S2), a sharing process of sharing the access information (step S3), a training process of training a model based on the access information (step S4), and a detection process of detecting an exceptional access event using the model (step S5). The processes in steps S2 to S5 are sequentially described in detail below.

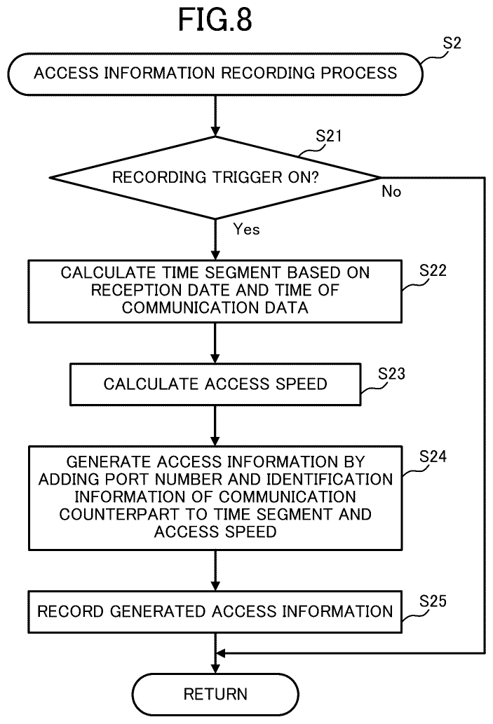

As illustrated in FIG. 8, in the access information recording process in step S2, the processor 31 determines whether a recording trigger held by the PLC 100 is ON (step S21). The recording trigger is a flag with a value indicating ON or OFF. The value is set by the user or by external application software. When the recording trigger is determined not to be ON (No in step S21), the process performed by the PLC 100 returns from the access information recording process in FIG. 8 to the PLC process in FIG. 7.

When the recording trigger is determined to be ON (Yes in step S21), the packet processor 12 calculates, based on the date and time of reception of the packet received by the communicator 11 as communication data, a time segment including the reception date and time (step S22). When the length of the time segment is one second as illustrated in FIG. 3, the packet processor 12 may round down the number of seconds in the date and time of reception to the decimal point. When the unit of the reception date and time is different from the unit of the time segment, the packet processor 12 also converts the units.

The packet processor 12 then calculates the access speed (step S23). In the example in FIG. 3, the packet processor 12 calculates the size of the packet as the speed. The packet processor 12 then adds the identification information and the port number of the communication counterpart to the time segment calculated in step S22 and the access speed calculated in step S23 to generate access information (step S24). More specifically, the packet processor 12 generates access information including the time segment and the access speed associated with the IP address indicating the source of the packet and the port number specified by the packet.

The packet processor 12 then records the access information generated in step S24 (step S25). More specifically, the packet processor 12 adds the generated access information as new row data to the transmission access information 131 in the storage 13. The process performed by the PLC 100 then returns from the access information recording process in FIG. 8 to the PLC process illustrated in FIG. 7.

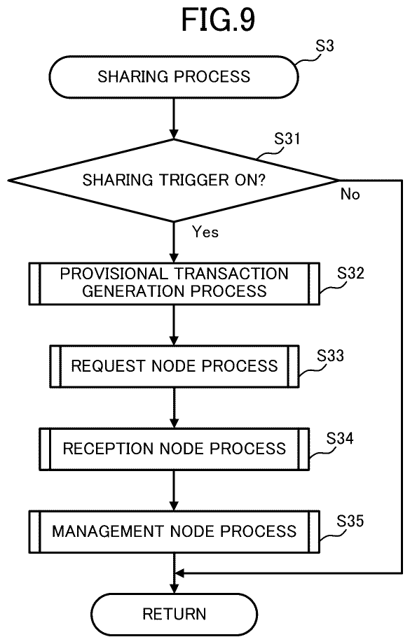

As illustrated in FIG. 9, in the sharing process in step S3, the sharer 14 determines whether a sharing trigger held by the PLC 100 is ON (step S31). The sharing trigger is a flag with a value indicating ON or OFF. The value is set by the user or by external application software. When the sharing trigger is determined not to be ON (No in step S31), the process performed by the PLC 100 returns from the sharing process in FIG. 9 to the PLC process in FIG. 7.

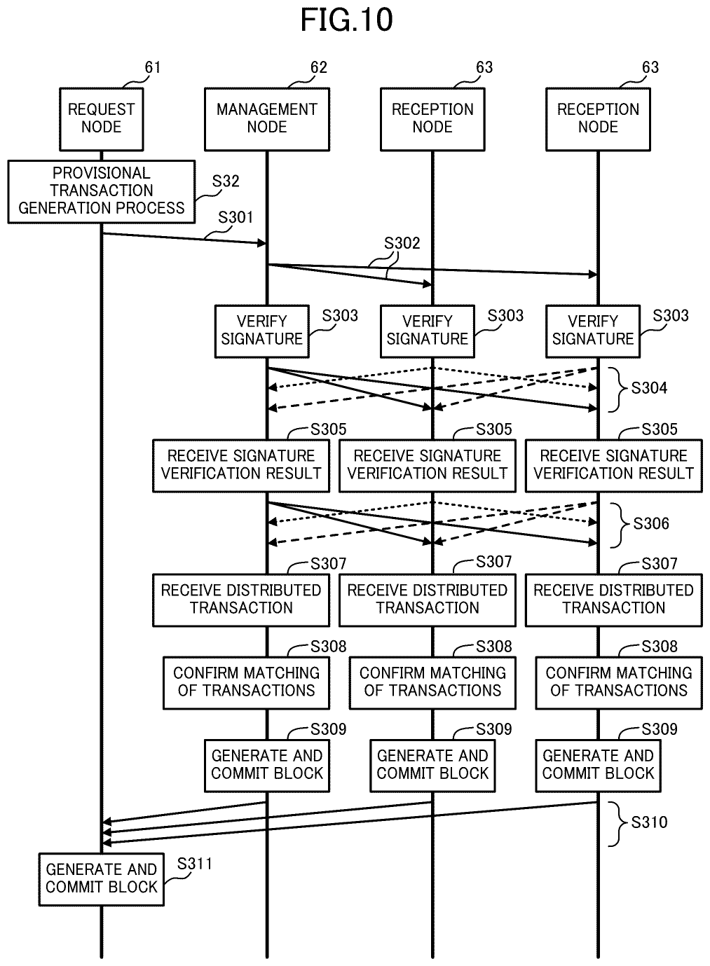

When the sharing trigger is determined to be ON (Yes in step S31), the sharer 14 performs a provisional transaction generation process of generating a provisional transaction that includes access information to be provided to the other PLCs 100 (step S32), a request node process as a node to request a consensus to commit a block that includes the provisional transaction (step S33), a reception node process as a node to receive the request for the consensus (step S34), and a management node process as a node to manage the consensus (step S35). These processes follow, for example, an algorithm referred to as Practical Byzantine Fault Tolerance (PBFT). The provisional transaction generation process, the request node process, the reception node process, and the management node process may be performed in parallel. The relationship between the request node, the reception node, and the management node is now described with reference to the sequence diagram in FIG. 10.

In FIG. 10, a request node 61, a management node 62, and reception nodes 63 correspond to the PLCs 100 connected to the network NW. When one of the multiple PLCs 100 determines that new data to be committed to the distributed ledger has been generated, the PLC 100 performs the provisional transaction generation process and the request node process as the request node 61. A specific PLC 100 of the PLCs 100 other than the request node 61 performs the management node process as the management node 62. The PLCs 100 other than the request node 61 and the management node 62 perform the reception node process as the reception nodes 63. Each PLC 100 may thus be either the request node or the reception node at different times.

A specific PLC 100 may be predetermined to serve as the management node 62. For example, the PLC 101 may be predetermined as the management node 62. When the PLC 101 serves as the request node 61, the PLC 102 may be predetermined to serve as the management node 62. Any one PLC 100 other than the request node 61 may be selected each time as the management node 62 under predetermined rules. For example, the request node 61 may request the management node 62 that is the PLC 100 with the lowest value IP address among the PLCs 100 that can communicate through the network NW to manage a consensus.

As illustrated in FIG. 10, the request node 61 performs the provisional transaction generation process (step S32) and transmits the generated provisional transaction to the management node 62 (step S301). The management node 62 distributes the provisional transaction received from the request node 61 to the reception nodes 63 (step S302).

Subsequently, the management node 62 and the reception nodes 63 each verify the signature included in the provisional transaction (step S303). When determining that the signature is correct, the management node 62 and the reception nodes 63 each distribute the signature verification result to the nodes other than the request node 61 (step S304), and receive the signature verification result distributed from other nodes (step S305). The management node 62 and the reception nodes 63 mutually verify that the provisional transaction has not been changed by the management node 62 by confirming that the number of nodes that have transmitted the correct signature verification result is greater than or equal to a threshold.

Subsequently, the management node 62 and the reception nodes 63 each distribute the provisional transaction to the nodes other than the request node 61 (step S306) and receive the provisional transaction distributed from the other nodes as a distributed transaction (step S307). The management node 62 and reception nodes 63 each then confirm that the number of distributed transactions matching the provisional transaction received in step S302 is greater than or equal to a threshold (step S308). In this manner, the management node 62 and the reception nodes 63 mutually confirm that the provisional transaction received by the management node 62 and the provisional transaction received by the reception nodes 63 match each other.

Subsequently, the management node 62 generates a block including the provisional transaction, commits the block to the distributed ledger held by the sharer 14 in the management node 62 (step S309), and notifies the request node 61 of the commitment result (step S310). Similarly, each reception node 63 generates a block including the provisional transaction, commits the block to the distributed ledger held by the sharer 14 in the reception node 63 (step S309), and notifies the request node 61 of the commitment result (step S310).

When the number of nodes that have notified the request node 61 of the commitment result is greater than or equal to a threshold, the request node 61 determines that a consensus to commit the block has been reached by the management node 62 and the reception nodes 63, generates a block including the provisional transaction, and commits the block to the distributed ledger held by the sharer 14 in the request node 61 (Step S311). In this manner, the request node 61, the management node 62, and the reception nodes 63 mutually verify whether blocks can be committed, and then commit the blocks to the distributed ledger.

The provisional transaction generation process (step S32), the request node process (step S33), the reception node process (step S34), and the management node process (step S35) illustrated in FIG. 9 are now each sequentially described in detail.

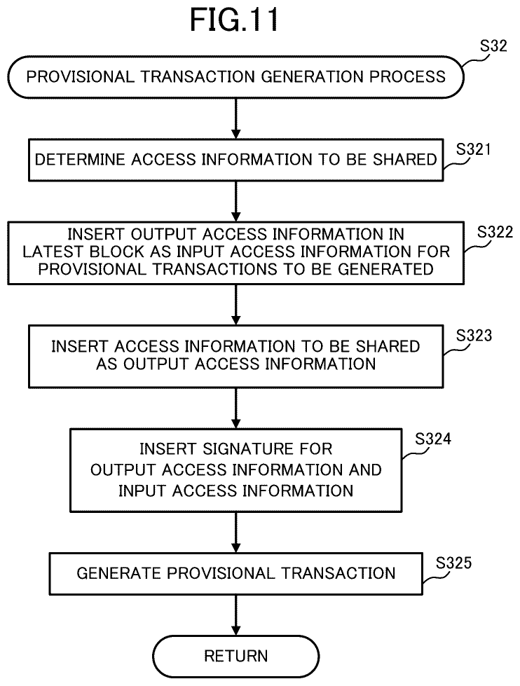

The provisional transaction generation process (step S32) illustrated in FIG. 11 is mainly performed by the sharer 14 in the request node 61. In the provisional transaction generation process, the sharer 14 determines the access information to be shared by transmitting the access information to the other nodes (step S321). More specifically, when the number of access information pieces added to the transmission access information 131 and yet to be committed to the distributed ledger reaches a predetermined number or greater, the sharer 14 determines the access information pieces to be the access information to be shared. The method for determining the access information to be shared may be changed as appropriate. For example, the sharer 14 may sort the packet reception date and time in descending order and process the access information piece with the latest date and time stored at the top, or may sort the access information pieces in descending or ascending order by the number assigned to each access information piece in the transmission access information 131 and process the access information piece stored at the top. The sharer 14 may exclude, from the access information to be shared, any access information piece satisfying a predetermined condition among the pieces of the transmission access information 131. Every time when access information is generated based on a single access event to the communicator 11, the sharer 14 may determine the generated access information to be access information to be shared.

Subsequently, the sharer 14 inserts, as the input access information 421 for the provisional transaction to be generated, the output access information 422 in the latest block 40 recorded with the distributed ledger (step S322). The sharer 14 then inserts, as the output access information 422 for the provisional transaction, the access information determined to be shared in step S321 (step S323). The sharer 14 then generates a signature for the input access information 421 inserted in step S322 and the output access information 422 inserted in step S323 and inserts the signature (step S324). The signature is a hash value acquired by applying a hash function to the connected character strings of the input access information 421 and the output access information 422. However, information acquired by other methods may be used as the signature. In this manner, the sharer 14 generates the provisional transaction including the input access information 421 in step S322, the output access information 422 in step S323, and the signature in step S324 (step S325).

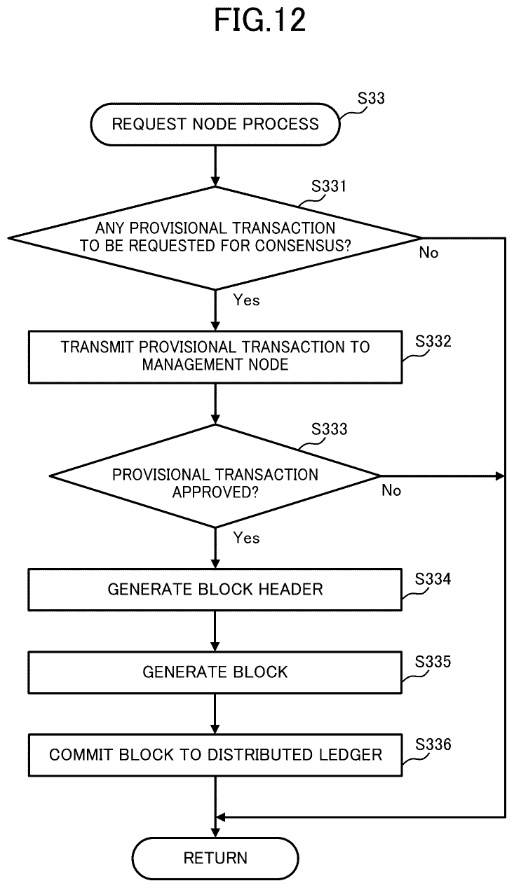

The request node process illustrated in FIG. 12 (step S33) is mainly performed by the sharer 14 in the request node 61. In the request node process, the sharer 14 determines whether any provisional transaction to be requested for a consensus has been generated (step S331). When the sharer 14 determines that no such provisional transaction has been generated (No in step S331), the request node process ends, and the process performed by the PLC 100 returns to the sharing process in FIG. 9.

When determining that such a provisional transaction has been generated (Yes in step S331), the sharer 14 transmits the provisional transaction to the management node 62 (step S332). Step S332 corresponds to step S301 in FIG. 10.

Subsequently, the sharer 14 determines whether the provisional transaction transmitted in step S332 has been approved (step S333). More specifically, the sharer 14 determines whether the number of nodes that has approved commitment of the provisional transaction is greater than or equal to a threshold. Step S333 corresponds to step S310 in FIG. 10.

Subsequently, the sharer 14 generates a block header 41 to be added to the provisional transaction (step S334) and generates a block 40 including the generated block header 41 and the provisional transaction as the transaction portion 42 (step S335). The sharer 14 then commits the generated block 40 to the distributed ledger (step S336). Steps S334 to S336 correspond to step S311 in FIG. 10.

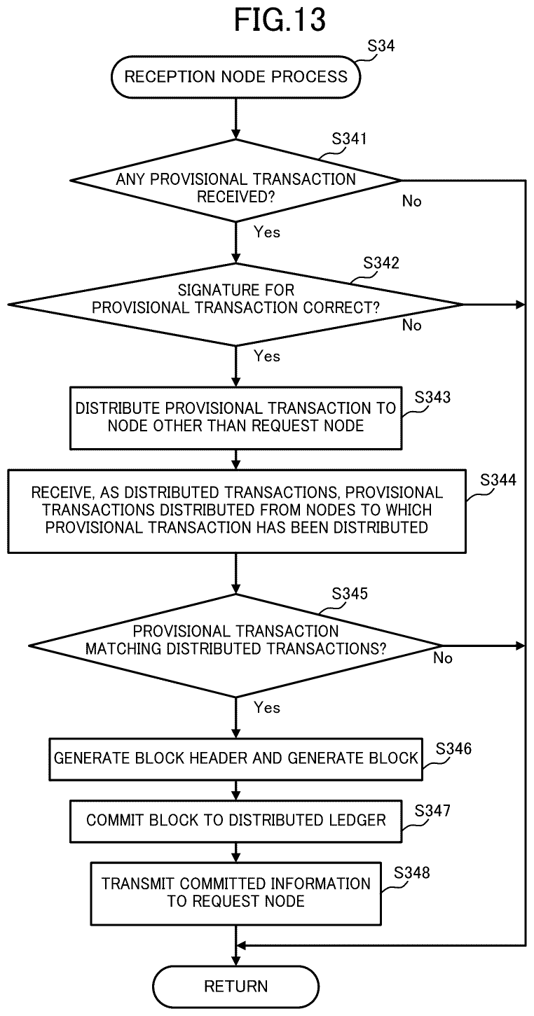

The reception node process illustrated in FIG. 13 (step S34) is mainly performed by the sharer 14 in each reception node 63. In the reception node process, the sharer 14 determines whether a provisional transaction has been received (step S341). This determination in step S341 is affirmative when step S302 in FIG. 10 is performed and a provisional transaction is distributed from the management node 62.

When determining that a provisional transaction has been received (Yes in step S341), the sharer 14 determines whether the signature for the received provisional transaction is correct (step S342). More specifically, the sharer 14 determines whether the signature included in the provisional transaction matches the signature generated from the input access information 421 and the output access information 422 included in the provisional transaction. When the signatures match, the sharer 14 notifies the nodes other than the request node 61 of the correctness of the signature. The sharer 14 then determines whether the number of nodes that have notified the sharer 14 of the correctness of the signature is greater than or equal to a threshold. The step S342 corresponds to steps S303 to S305 in FIG. 10.

When the signature of the provisional transaction is determined to be correct (Yes in step S342), the sharer 14 distributes the provisional transaction to the nodes other than the request node 61 (step S343). The step S343 corresponds to step S306 in FIG. 10.

The nodes to which the provisional transaction has been distributed perform the same processing as in step S343. The sharer 14 then receives the distributed transactions, or the provisional transactions distributed from the nodes to which the provisional transaction has been distributed (step S344). The step S344 corresponds to step S307 in FIG. 10.

Subsequently, the sharer 14 determines whether the provisional transaction received in step S341 matches the distributed transactions received in step S344 (step S345). More specifically, the sharer 14 compares each of the distributed transactions received from multiple distribution destinations in step S344 with the provisional transaction to determine whether the number of distributed transactions that match the provisional transaction is greater than a threshold. The step S345 corresponds to step S308 in FIG. 10.

When determining that the provisional transaction matches the distributed transactions (Yes in step S345), the sharer 14 generates a block header 41 and generates a block 40 including the block header 41 and the provisional transaction (step S346). The sharer 14 then commits the generated block 40 to the distributed ledger in the sharer 14 (step S347). The steps S346 and S347 correspond to step S309 in FIG. 10.

The sharer 14 then transmits the committed information to the request node 61 (step S348). The transmission of the committed information may be transmission of the block 40 committed in step S347, or may be a notification indicating that the provisional transaction has been approved. The step S348 corresponds to step S310 in FIG. 10. The process performed by the PLC 100 then returns to the sharing process illustrated in FIG. 9. When the determination in step S341, S342, or S345 is negative (No in step S341, No in step S342, or No in step S345), the process performed by the PLC 100 returns to the sharing process illustrated in FIG. 9 without the sharer 14 approving the provisional transaction.

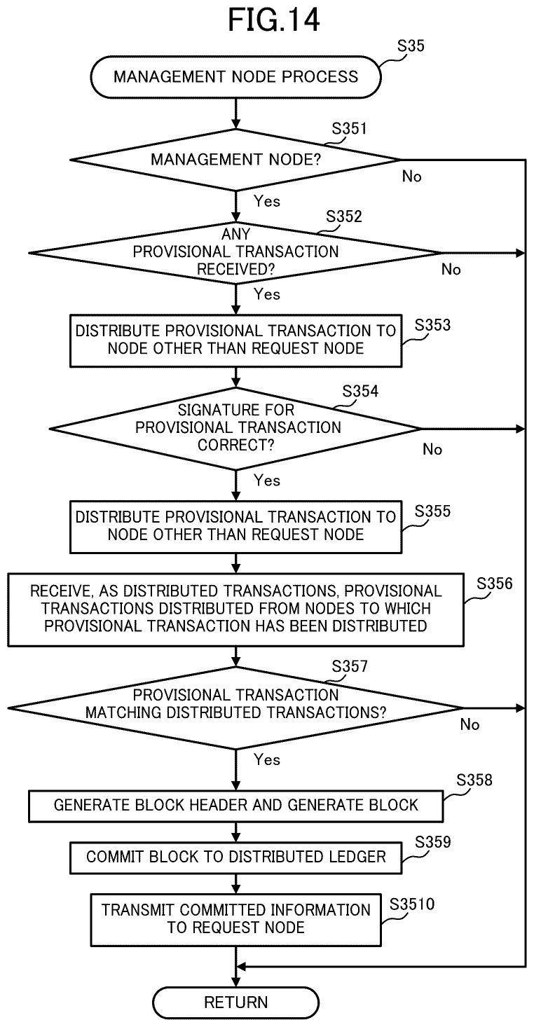

The management node process illustrated in FIG. 14 (step S35) is mainly performed by the sharer 14 in the management node 62. In the management node process, the sharer 14 determines whether the PLC 100 including the sharer 14 is a management node (step S351). When determining that the PLC 100 is a management node (Yes in step S351), the sharer 14 determines whether a provisional transaction has been received (step S352). When step S301 in FIG. 10 is performed, the determination in step S352 is affirmative.

When determining that a provisional transaction has been received (Yes in step S352), the sharer 14 distributes the provisional transaction to the reception nodes 63 (step S353). The step S353 corresponds to step S302 in FIG. 10.

In and after step S353, the sharer 14 performs steps S354 to S3510 that are the same as steps S342 to S348 in the reception node process. When the determination in step S351 or S352 is negative (No in step S351 or No in step S352), the process performed by the PLC 100 returns to the sharing process illustrated in FIG. 9 without the sharer 14 approving the provisional transaction.

As illustrated in FIG. 9, after the management node process ends, the process performed by the PLC 100 returns to the PLC process illustrated in FIG. 7, and then the training process (step S4) is performed.

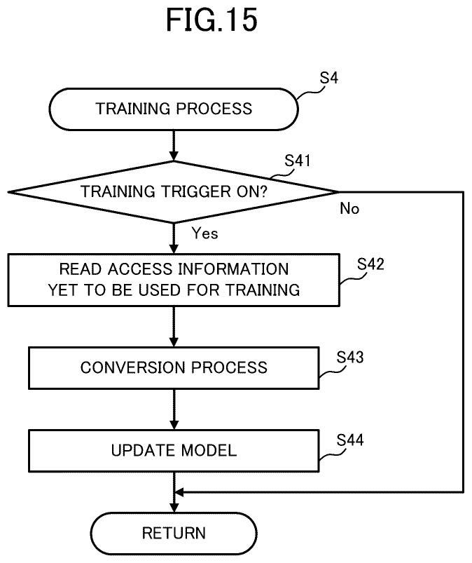

In the training process in step S4, as illustrated in FIG. 15, the trainer 15 determines whether a training trigger held by the PLC 100 is ON (step S41). The training trigger is a flag with a value indicating ON or OFF. The value is set by the user or by external application software. When the training trigger is determined not to be ON (No in step S41), the process performed by the PLC 100 returns from the training process in FIG. 15 to the PLC process in FIG. 7.

When determining that the training trigger is ON (Yes in step S41), the trainer 15 reads access information yet to be used for training from the storage 13 (step S42). More specifically, the trainer 15 extracts, from the transmission access information 131 and the reception access information 132, access information pieces not used for training in the past.

The trainer 15 then performs a conversion process of converting the access information to a format appropriate for training (step S43). The conversion process may include extracting the feature values illustrated in FIG. 6. Each element included in the access information may have a value with a different range. The conversion process may thus be normalization or standardization of such elements. For example, the range of the IP address values and the range of values possible as the speed may both be normalized and converted to a range from zero to one. As the training data increases, the computational complexity in updating the training model may increase exponentially. Conversion may be performed to reduce the computational complexity in updating the training model.

The trainer 15 then updates the model based on the access information with the format converted in step S43 (step S44). The process performed by the PLC 100 then returns from the training process in FIG. 15 to the PLC process in FIG. 7.

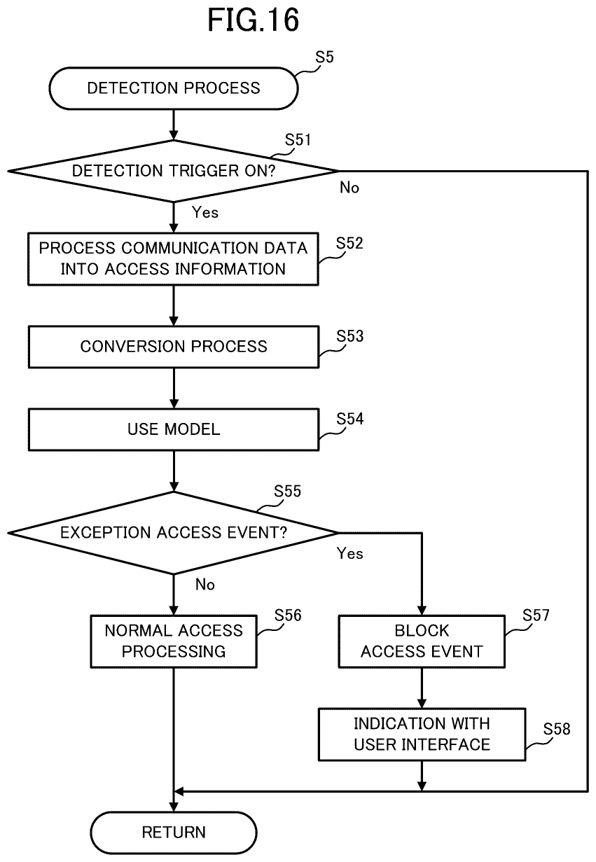

In the detection process in step S5, the detector 16 determines whether a detection trigger held by the PLC 100 is ON as illustrated in FIG. 16 (step S51). The detection trigger is a flag with a value indicating ON or OFF. The value is set by the user or by external application software. When the detection trigger is determined not to be ON (No in step S51), the process performed by the PLC 100 returns from the detection process in FIG. 16 to the PLC process in FIG. 7.

When the detection trigger is determined to be ON (Yes in step S51), the packet processor 12 processes the packets as communication data newly received by the communicator 11 into access information (step S52) and stores the processed packets into the storage 13.

The detector 16 then performs the same conversion process as in step S43 in FIG. 15 on the access information generated in step S52 (step S53), and uses the model trained by the trainer 15 (step S54) to determine whether the access event indicated by the access information is an exceptional access event (step S55).

When the access event is determined not to be an exceptional access event (No in step S55), the processor 18 performs normal access processing for the access event (step S56). For example, the processor 18 reads or writes the data requested by the access event. The process performed by the PLC 100 then returns from the detection process in FIG. 16 to the PLC process illustrated in FIG. 7.

When the access event is determined to be an exceptional access event (Yes in step S55), the processor 18 blocks the exceptional access event (step S57) and causes the indicator 17 to indicate the exceptional access event with the user interface (step S58). The process performed by the PLC 100 then returns from the detection process in FIG. 16 to the PLC process illustrated in FIG. 7.

As described above, when an exceptional access event is newly received, the processor 18 blocks the exceptional access event and indicates the exceptional access event with the user interface as a process different from the process performed for normal access events. Thus, unauthorized access events that occur exceptionally can be responded with a process different from a process for normal access events with lower processing load. Thus, the PLC system 1000 can have higher availability in occurrence of unauthorized access events.

For example, existing methods such as IP filtering are known. With IP filtering, trusted devices on the network NW are pre-registered with a whitelist to treat access events from such devices as authorized access events. However, when such a device is taken over or used as a jump server or the PLC 100 is accessed through IP spoofing, the existing methods described above have difficulty in protecting the PLC 100 adequately. In contrast, responding to exceptional access events by focusing on the frequency of the access events can protect the PLCs 100 against unauthorized access events.

Additionally, the existing methods described above filter access events based on initial settings. In contrast, each PLC 100 according to the present embodiment repeatedly trains the model with the trainer 15 and can thus detect exceptional access events as appropriate for access events occurring in the network NW.

In the example described above, the consensus among PLCs is reached based on the algorithm referred to as the PBFT. Based on the PBFT, the distributed ledger is durable against the fault of a node participating in the distributed ledger having a fault that prevents the node from updating the distributed ledger and against the fault of a transaction being rewritten by an outside attacker. The number of nodes to participate in the distributed ledger may be set by calculating backward from the number of fault tolerant nodes that has been predetermined. When the number of fault tolerant nodes is f, the number of nodes participating in the distributed ledger is to be 3f+1. For example, for f being 1, the participating nodes are four nodes as illustrated in FIG. 10.

Although the storage 13 storing the access information is included in each PLC 100 in the above example, the access information may be stored in a storage device external to the PLC 100, such as a network attached storage (NAS) or a memory card removably attachable to the PLC 100.

The trainer 15 may use a training method different from the above method. For example, the method may be a one-class support vector machine (SVM) that allows anomaly detection with relatively less computational complexity. When computing resources have no constraint in the future, methods such as the k-nearest neighbors method or the k-means method may be used. Deep neural networks, convolutional neural networks, or recurrent neural networks may also be used as training methods.

### Embodiment 2

Embodiment 2 is now described focusing on the differences from Embodiment 1. Like reference signs denote like or corresponding components in Embodiment 1. The present embodiment differs from Embodiment 1 in that the sharer 14 shares the detection results from the detector 16.

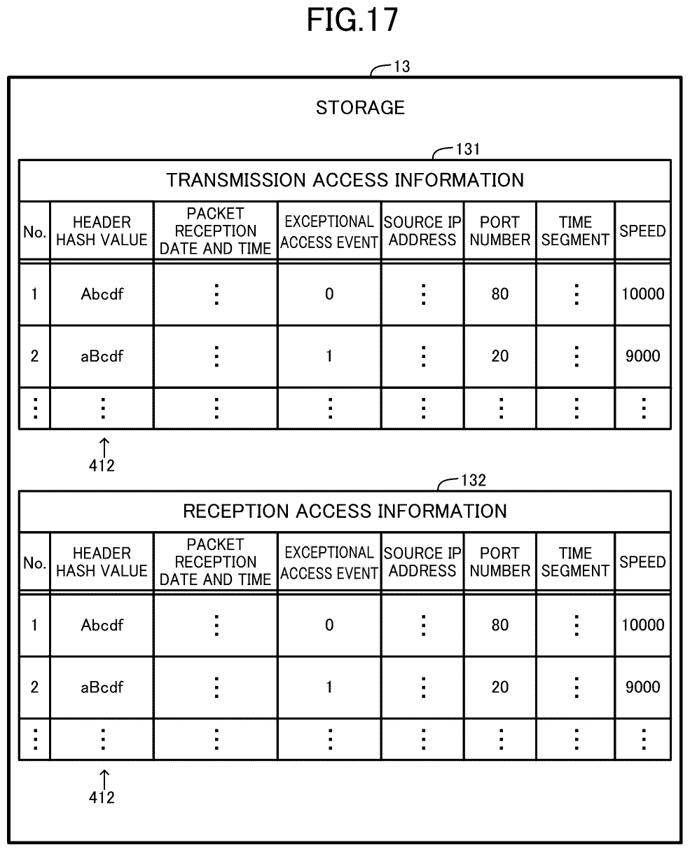

As illustrated in FIG. 17, the access information according to the present embodiment includes a header hash value 412 of a block 40 for sharing the access information and a flag indicating whether the access event indicated by the access information is detected as an exceptional access event by the detector 16. In FIG. 17, the flag value of 0 indicates a normal access event, and the flag value of 1 indicates an exceptional access event. The PLC 100 indicates, through the user interface, the access event determined to bean exceptional access event in any of other PLCs 100. More specifically, when the reception access information 132 includes access information with a flag value of 1, the indicator 17 indicates the exceptional access event indicated by the access information.

As described above, indicating the detection result of an exceptional access event in other PLCs 100 allows the user to refer to the detection result of the exceptional access event occurring in any of the other PLCs 100 having a fault.

### Embodiment 3

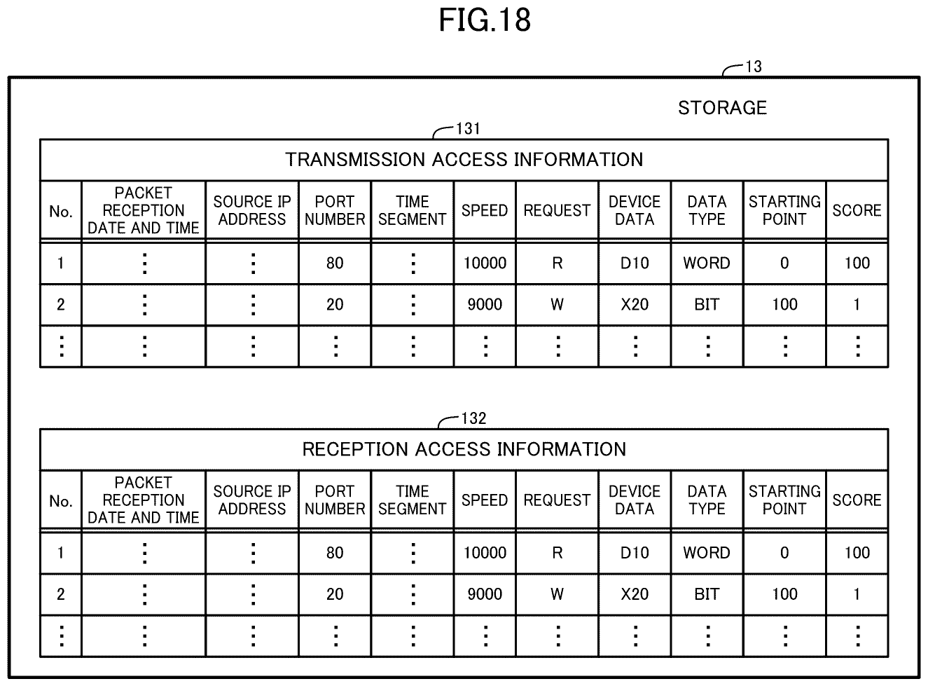

Embodiment 3 is now described focusing on the differences from Embodiment 1. Like reference signs denote like or corresponding components in Embodiment 1. As illustrated in FIG. 18, the present embodiment differs from Embodiment 1 in that the access information includes information about device data.

The PLC 100 usually shares data referred to as device data with other devices and controls equipment by manipulating the device data. For example, when a sensor device shares device data indicating sensing results with the PLCs 100, the sensing results are provided to the PLC 100. When the PLC 100 shares device data indicating operation commands with an actuator, the operation commands are provided to the actuator.

As illustrated in FIG. 18, when an access event to the communicator 11 requests reading or writing of device data, the packet processor 12 in each PLC 100 indicates, in a manner associated with one another, the request as reading or writing, the address of the device data, the data type of the device data, the starting point, and the scores. In FIG. 18, “R” indicates a reading request, and “W” indicates a writing request.

The sharer 14 also shares, for access events to the other PLCs 100, access information including such information about device data. The trainer 15 updates the model based on the access information. The information about the device data corresponds to an example of data access information.

As described above, training the model based on the information about the device data expectedly further increases identification accuracy for exceptional access events.

Although one or more embodiments of the present disclosure have been described above, the present disclosure is not limited to the above embodiments.

For example, the PLC system 1000 may include any number of PLCs 100.

When a public chain is used as the consensus algorithm, the block header 41 may include the Merkle Root representing hashed values of a list of nodes participating in the distributed ledger, the mining difficulty, and the nonce at the time of successful mining.

Embodiments 2 and 3 described above may be combined. In Embodiments 2 and 3, although elements are added to the access information in Embodiment 1, the added elements are not limited to the elements described in Embodiments 2 and 3. For example, the access information may additionally include one or more items of information including files transmitted from the communication counterpart through the network NW, remote operation information such as remote RUN to start the PLC 100 remotely and remote STOP to stop the PLC 100 remotely, information indicating changes in network settings such as IP addresses, and information indicating changes in clock data.

In the example described above, the access information indicates both the time at which an access event has occurred and the time segment including the time, the access information may indicate at least one of the time or the time segment.

The functions of the PLC 100 can be implemented by a dedicated hardware device or by a common computer system.

For example, the program P1 may be stored in a non-transitory computer-readable recording medium, typically a flexible disc, a compact disc read-only memory (CD-ROM), a digital versatile disc (DVD), or a magneto-optical (MO) disk, and may be distributed. The program P1 can be installed in a computer to provide a device that performs the above processing.

The program P1 may be stored in a disk device included in a server on a communication network, typically the Internet, and may be, for example, superimposed on a carrier wave to be downloaded to a computer.

The processing described above may also be performed by the program P1 being activated and executed while being transferred through a network, typically the Internet.

The processing described above may also be performed by entirely or partially executing the program P1 on a server while a computer is transmitting and receiving information about the processing through a communication network.

In the system with the above functions implementable partially by the operating system (OS) or through cooperation between the OS and applications, portions executable by applications other than the OS may be stored in a non-transitory recording medium that may be distributed or may be downloaded to a computer.

Means for implementing the functions of the PLC 100 is not limited to software. The functions may be partially or entirely implemented by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to betaken in a limiting sense, and the scope of the invention is defined only by the included claims, along with the full range of equivalents to which such claims are entitled.

### INDUSTRIAL APPLICABILITY

The technique according to one or more embodiments of the present disclosure is used to improve the security of systems operating at FA sites.

### REFERENCE SIGNS LIST

11 Communicator
12 Packet processor
13 Storage
14 Sharer
15 Trainer
16 Detector
17 Indicator
18 Processor
20 Support device
21 Setter
22 Display
30 FA device
31 Processor
32 Main storage
33 Auxiliary storage
34 Input device
35 Output device
36 Communicator
37 Internal bus
40 Block
41 Block header
42 Transaction portion
50 Area
51 to 53 Sampling point
61 Request node
62 Management node
63 Reception node
100 to 103 PLC
131 Transmission access information
132 Reception access information
411 Previous header hash value
412 Header hash value
413 Generation date and time information
421 Input access information
422 Output access information
423 Signature
1000 PLC system
NW Network
P1 Program

1. A programmable controller, comprising:
processing circuitry to
receive an access event from an external device and perform communication through a network;
train a model to identify an exceptional access event occurring less frequently than other access events based on a history of received access events;
detect the exceptional access event from a newly received access event using the trained model; and
process the detected exceptional access event, wherein
the history includes identification information identifying a communication device that has caused an received access event in the network in a manner associated with at least one of a time of the access event or a predetermined time segment including the time, and
the processing circuitry trains, for the time segment, the model to identify the exceptional access event occurring less frequently than the other access events occurring in the time segment.

2. The programmable controller according to claim 1, wherein
the processing circuitry blocks the exceptional access event.

3. The programmable controller according to claim 1, wherein
the processing circuitry indicates information about the exceptional access event through a user interface.

4. (canceled)

5. The programmable controller according to claim 3, wherein
the identification information is an address of the communication device in the network,
the history includes, in a manner associated with one another, the address of the communication device, a port number specified by the access event, and at least one of the time of the access event or the time segment including the time, and
the processing circuitry trains, for the time segment, the model to identify the exceptional access event based on the address and the port number.

6. A programmable controller comprising:
processing circuitry to
receive an access event from an external device and perform communication through a network;
train a model to identify an exceptional access event occurring less frequently than other access events based on a history of received access events;
detect the exceptional access event from a newly received access event using the trained model; and
process the detected exceptional access event, wherein
the programmable controller shares device data with another device,
the history includes, for an access event requesting reading or writing of the device data, data access information about the reading or the writing, and
the processing circuitry trains the model to identify the exceptional access event based on the data access information.

7. A programmable controller comprising:
processing circuitry to
receive an access event from an external device and perform communication through a network;
train a model to identify an exceptional access event occurring less frequently than other access events based on a history of received access events;
detect the exceptional access event from a newly received access event using the trained model; and
process the detected exceptional access event, wherein
the programmable controller is connectable to another programmable controller,
the processing circuitry provides first access information indicating the history to the other programmable controller and acquires, from the other programmable controller, second access information indicating an access event to the other programmable controller to share the first access information and the second access information with the other programmable controller, and
the processing circuitry trains the model based on the first access information and the second access information.

8.-9. (canceled)
